(19) United States
(12) Patent Application Publication
(10) Pub. No.: US 2012/0120174 A1
(43) Pub. Date: May 17, 2012

(54) INKJET PRINTING SYSTEM

(75) Inventors: Tetsuo HOSOYA, Ibaraki-ken (JP); Toshihiro ENDO, Ibaraki-ken (JP); Tomohiko SHIMODA, Ibaraki-ken (JP); Ryota YAMAGISHI, Ibaraki-ken (JP)

(73) Assignee: RISO KAGAKU CORPORATION, Tokyo (JP)

(21) Appl. No.: 13/292,613

(22) Filed: Nov. 9, 2011

(30) Foreign Application Priority Data
Nov. 15, 2010 (JP) P2010-254802

(51) Int. Cl. B41J 2/01

(52) U.S. Cl. 347/104

(57) ABSTRACT

An inkjet printing system using a non-aqueous ink composition, wherein
the head holder is configured to define an upper spatial region and a lower spatial region relative to the head holder, and is provided with a plurality of air communication holes for air communication between the upper spatial region and the lower spatial region, and
the non-aqueous ink composition comprises a pigment, a pigment dispersant in such an amount that a mass ratio in solid content of the pigment dispersant to the pigment ranges from 0.2 to 2.0, and an organic solvent, the pigment dispersant comprising
(A) a polyamide having a polyester side chain and/or a copolymer of vinylpyrrolidone and a C₁₀₋₄₀ alkene, and
(B) an alkyl (alkyl)acrylate copolymer dispersed in the non-aqueous ink composition.

### CROSS REFERENCE TO RELATED APPLICATIONS

This Application is based upon and claims the benefit of priority from Japanese Patent Applications No. 2010-254802 filed on Nov. 15, 2010, the entire contents of which are incorporated by reference herein.

### FIELD OF THE INVENTION

The present invention relates to an inkjet printing system, and specifically to an inkjet printing system comprising an inkjet printer having a head holder provided with air communication holes and using a non-aqueous ink composition comprising a combination of specific dispersants to significantly reduce staining of images with satellites.

### BACKGROUND OF THE INVENTION

An inkjet printer includes a base member for printing, hereinafter referred to as a platen, disposed in position opposing an array of inkjet heads adapted to eject ink. The platen has multiple holes formed through the platen to produce suction forces at the obverse side for use to correct deformations of a sheet of paper, such as curl or cockling. The platen has a porous platen belt sliding thereon, sucking the paper sheet thereon to transfer.

Among holes of the platen belt, those that are not closed up with the paper sheet cause turbulences of air flowing from around inkjet heads into the through holes of the platen, as they pass over the through holes. The turbulences of air tend to diffuse fine droplets of ink ejected from the inkjet heads, hereinafter referred to ink mist, causing the paper sheet to be stained with mist, which staining may be hereinafter referred to as staining with satellites.

To avoid such staining with satellites, there have been techniques for improvements proposed for the printer, or for the ink composition. For instance, Japanese Patent Application Laid-Open No. 2010-89289 proposes forming an extended portion of the holes of a platen belt, and Japanese Patent Application Laid-Open No. 2007-326930 proposes incorporating a vinyl chloride resin having a group such as a sulfate group or a sulfonic acid group in a non-aqueous inkjet ink.

### SUMMARY OF THE INVENTION

### Problems to be Solved by the Invention

However, even with improvements in a printer or an ink composition respectively, it is still difficult to sufficiently suppress satellites. In particular, in a printing on a thick recording medium such as an envelope, a distance between the recording medium and an array of head nozzles is relatively larger, so that staining with satellites tends to occur. In this respect, it is an object of the present invention to provide an inkjet printing system adapted for a printing free of satellite stains even on a thick recording medium.

### Means to Solve the Problems

Thus, the present invention is an inkjet printing system using a non-aqueous ink composition,

the inkjet printer comprising:

a inkjet head configured to hold a non-aqueous ink composition;

a head holder configured to hold the inkjet head;

a platen disposed under the head holder in a position opposing the head holder, the platen having a plurality of through holes formed therethrough;

a suction device configured to produce suction forces at the plurality of through holes; and

a porous platen belt configured to travel on the platen, and to suction a sheet of paper thereon to transfer, wherein

the head holder is configured to define an upper spatial region and a lower spatial region relative to the head holder, and is provided with a plurality of air communication holes for air communication between the upper spatial region and the lower spatial region, within a range of a projection of the platen on the head holder, and

the non-aqueous ink composition comprises a pigment, a pigment dispersant in such an amount that a mass ratio in solid content of the pigment dispersant to the pigment ranges from 0.2 to 2.0, and an organic solvent, the pigment dispersant comprising

(A) a polyamide having a polyester side chain and/or a copolymer of vinylpyrrolidone and a C₁₀₋₄₀ alkene, and
(B) an alkyl (alkyl)acrylate copolymer.

### Effects of the Invention

The aforesaid inkjet printer comprises a head holder having a plurality of air communication holes, which allow the formation of airflow passing through the air communication holes. This prevents the occurrence of turbulent air around inkjet heads and the formation of ink mists, reducing satellite stains. Further, the non-aqueous ink composition in the present invention, which may be hereinafter referred to as “ink composition,” comprises a combination of component (A) dissolved in the organic solvent and component (B) dispersed in the organic solvent, which suppresses the viscosity change with temperature and achieves a highly stable dispersion of pigment, resulting in the suppression of staining with satellite through suppression of satellite formation.

### BRIEF DESCRIPTION OF THE DRAWINGS

FIG. 1 is a schematic diagram of configuration of an inkjet printer according to a first embodiment of the present invention.

FIG. 2A is a plan view of a head holder.

FIG. 2B is a perspective view of a head holder.

FIG. 3 is a plan view of a platen.

FIG. 4 is a fragmentary enlarged sectional view of a printing section.

FIG. 5 is a diagram showing air communication holes according to a first embodiment of the present invention.

FIG. 6 is a diagram showing air communication holes according to a second embodiment.

FIG. 7 is a diagram showing air communication holes according to a modification of the second embodiment.

FIG. 8 is a diagram showing air communication holes according to a third embodiment.

FIG. 9 is a diagram showing air communication holes according to a fourth embodiment.

### DESCRIPTION OF EMBODIMENTS

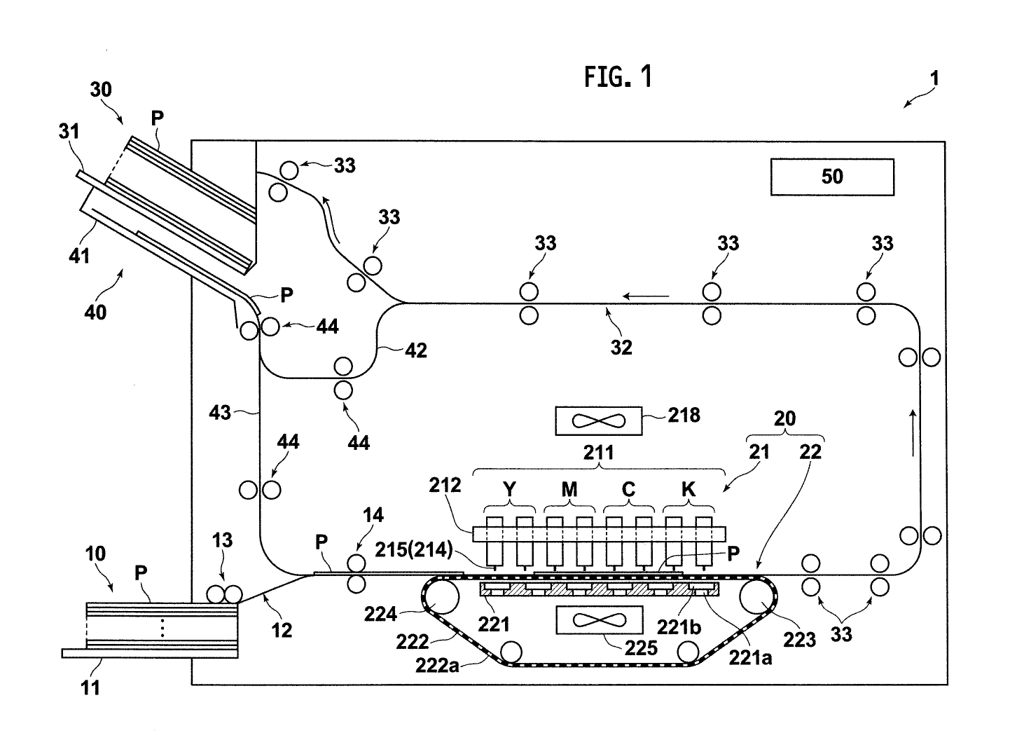

There will be described printers according to embodiments of the present invention, with reference to the drawings. FIG. 1 is a schematic diagram of configuration of an inkjet printer 1 according to a first embodiment of the present invention. The inkjet printer 1 includes a sheet feed section 10, a printing section 20, a sheet discharge section 30, a switchback section 40, and a controller 50.

The sheet feed section 10 is to feed a sheet of paper P to the printing section 20, which is configured with a feed rack 11, a feed route 12, a feed roller pair 13, and a timing roller pair 14. The feed rack 11 is provided at a lower lateral side of the inkjet printer 1, to mount thereon unprinted paper sheets P. The feed route 12 guides a paper sheet P from the feed rack 11 to the printing section 20. The feed roller pair 13 takes out a paper sheet P one by one from the feed rack 11. The timing roller pair 14 sends a paper sheet P at a prescribed timing to the printing section 20.

The printing section 20 is to load a paper sheet P from the sheet feed section 10 into the printing section 20, eject ink onto the paper sheet P for printing thereon, and unload the paper sheet P toward the sheet discharge section 30. The printing section 20 is configured with a head unit 21 and a platen unit 22. The head unit 21 ejects droplets of ink. The platen unit 22 transfers a paper sheet P under the head unit 21. The head unit 21 and the platen unit 22 will be detailed later on.

The sheet discharge section 30 is to discharge a printed paper sheet P and is configured with a sheet mounter 31, a sheet discharge route 32, and a discharge roller pair 33. The sheet mounter 31 is provided at an upper lateral side of the inkjet printer 1 to mount thereon printed paper sheets P. The sheet discharge route 32 guides a printed paper sheet P from the printing section 20 with its printed side facing downwards to the sheet mounter 31. The discharge roller pair 33 transfers a paper sheet P on the sheet discharge route 32 one by one.

The switchback section 40 is to switchback a one-side printed paper sheet P and to again send paper sheet P to the printing section 20 with its unprinted side facing upwards, and is configured with a buffer space 41, a branch route 42, a sheet re-feed route 43, and a switchback roller pair 44. The buffer space 41 extends at the back of the sheet mounter 31. The branch route 42 is branched in a midway of the sheet discharge route 32 to guide a paper sheet P to the buffer space 41. The sheet re-feed route 43 guides a paper sheet P from the buffer space 41 to the timing roller pair 14. The switchback roller pair 44 sends out a paper sheet P one by one on the branch route 42 or the sheet re-feed route 43.

The controller 50 is adapted to control each section, and to process instructions from user through a non-depicted operation panel.

Now, operations of the inkjet printer 1 are explained. First, an unprinted paper sheet P is taken out by the feed roller pair 13 from the sheet feed rack 11 onto the feed route 12. The paper sheet P on the feed route 12 is then sent at a prescribed timing by the timing roller pair 14 into the printing section 20.

In the printing section 20, the paper sheet P is transferred by the platen unit 22 at a prescribed speed, while the head unit 21 ejects droplets of ink onto the paper sheet P to make a print thereon. The paper sheet P thus printed is sent out by the discharge roller pair 33 one by one onto the sheet discharge route 32. Then, the paper sheet P is guided with its printed side facing downwards to be discharged onto the sheet mounter 31.

For a both-side printing, a non-depicted route selector installed in a way of the sheet discharge route 32 is operated to send the paper sheet P on the sheet discharge route 32 to the branch route 42 and then into the buffer space 41. The paper sheet P sent into the buffer space 41 is switched back to the sheet re-feed route 43, and is again guided to the timing roller pair 14, and to the printing section 20. In this text, a direction perpendicular to the direction in which the paper sheet P is transferred as “a main scan direction”, and the direction in which the paper sheet P is transferred is referred as “a sub-scan direction.”

Description is now made of the head unit 21 in the printing section 20. The head unit 21 includes a plurality of inkjet heads 211 for ejecting droplets of ink onto a paper sheet P, and a head holder 212 for holding the inkjet heads 211.

The head holder 212 is disposed above the after-mentioned platen 221 in position opposing the platen 221. The head holder 212 is configured to define an upper spatial region US and a lower spatial region LS relative to the head holder 212. The head holder 212 has an air communication hole 216 within a projection range PR of the platen 221, allowing communication of air between the upper spatial region US and the lower spatial region LS.

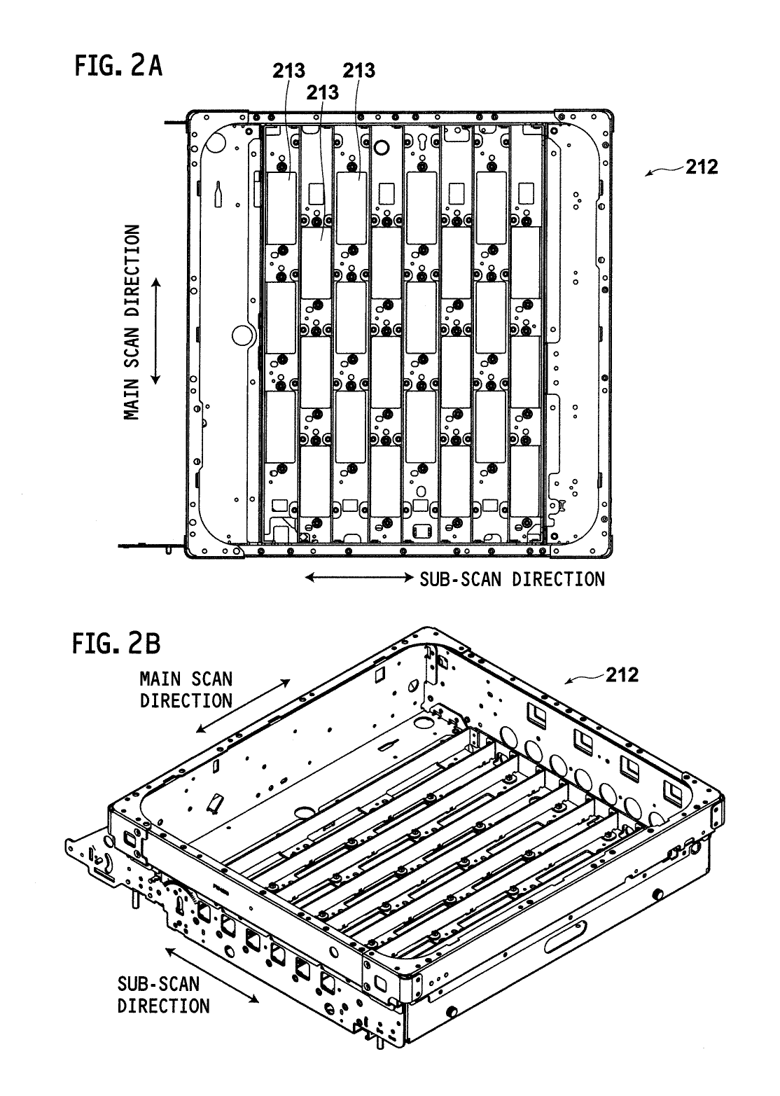

FIG. 2A is a plan view, and FIG. 2B is a perspective view, both showing the head holder 212. The upper view is a plan view of the head holder 212. The lower view is a perspective view of the head holder 212. As illustrated in the upper view, the head holder 212 has a plurality of fixing holes 213 formed therethrough at prescribed intervals to constitute zigzagged arrays in the main scan direction, as well as in the sub-scan direction. In this embodiment, the head holder 212 has 24 fixing holes 213, in total, formed therethrough. Details of the air communication holes 216 will be given later. It should be noted that the number of fixing holes 213 and the layout are not specifically limited.

At the head holder 212, each fixing hole 213 has one inkjet head 211 inserted thereinto, and held in the inserted state by using non-depicted fixtures such as flanges. FIG. 1 is again referred to, for description. The inkjet head 211 has, at the bottom side, a plurality of inkjet nozzles 214 for ejecting ink droplets downward onto a paper sheet P. The inkjet nozzles 214 are arranged in the sub-scan direction along the bottom side of the inkjet head 211, constituting a linear nozzle line 215. Thus, each inkjet head 211 ejects ink droplets in a unit of line onto a paper sheet P.

In this embodiment, a set of six inkjet heads 211 are used for ejecting any one color of yellow (Y), magenta (M), cyan (C), and black (K) colors.

Description is now made of the platen unit 22, referring again to FIG. 1. The platen unit 22 includes a platen 221, an endless platen belt 222, a drive roller 223, a driven roller 224, and a fan 225. The platen 221 is disposed under the head unit 21, in position opposing the head holder 212. The platen belt 222 is stretched to slide on the platen 221. The drive roller 223 cooperates with the driven roller 224 to drive the platen belt 222. The fan 225 produces a negative pressure in a spatial region defined under the platen 221.

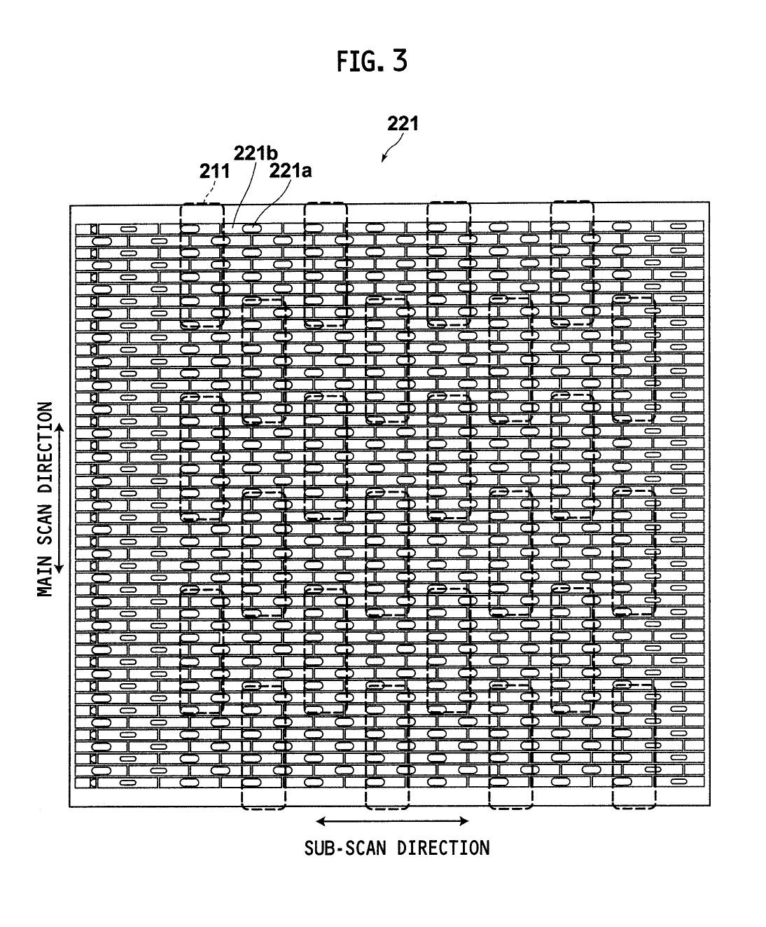

FIG. 3 is a plan view of the platen 221. It is noted that, in FIG. 3, regions of projections of the inkjet heads 211 are shown by broken lines. The platen 221 is configured as a plate member with zigzagged arrays of a plurality of elongate through holes 221a formed over a region for the platen belt 222 to pass across. The platen 221 has arrays of recesses 221b, which communicate with the arrays of through holes 221a, formed on the surface.

The platen belt 222 has zigzagged arrays of a plurality of belt holes 222a formed therethrough. As the fan 225 makes negative pressures in the spatial region under the platen 221, suction forces are produced at the arrays of through holes 221a. It is noted that the spatial region under the platen 221 is closed tightly by a non-depicted frame.

As the platen belt 222 slides on the platen 221, suction forces are produced also at belt holes 222a passing over recesses 221b. Suction forces produced at belt holes 222a get maximal when passing over through holes 221a. Arrays of inkjet nozzles 214 are set at a distance off the surface of the platen belt 222 in the range of approximately from 1 to 3 mm depending on the thickness of a paper sheet P used.

The timing roller pair 14 sends a paper sheet P, which is detected at an upstream end thereof in the sub-scan direction by a non-depicted sensor, and suctioned onto the platen belt 222 by belt holes 222a, and transferred. As a paper sheet P passes across arrays of positions UP right under inkjet nozzles 214 at a prescribed speed, ink droplets are ejected from inkjet heads 211 in a line to form images on the paper sheet P. It is noted that the controller 50 is adapted to control the timings of the ejection of ink by the head unit 21, and the transfer of a paper sheet P by the platen unit 22.

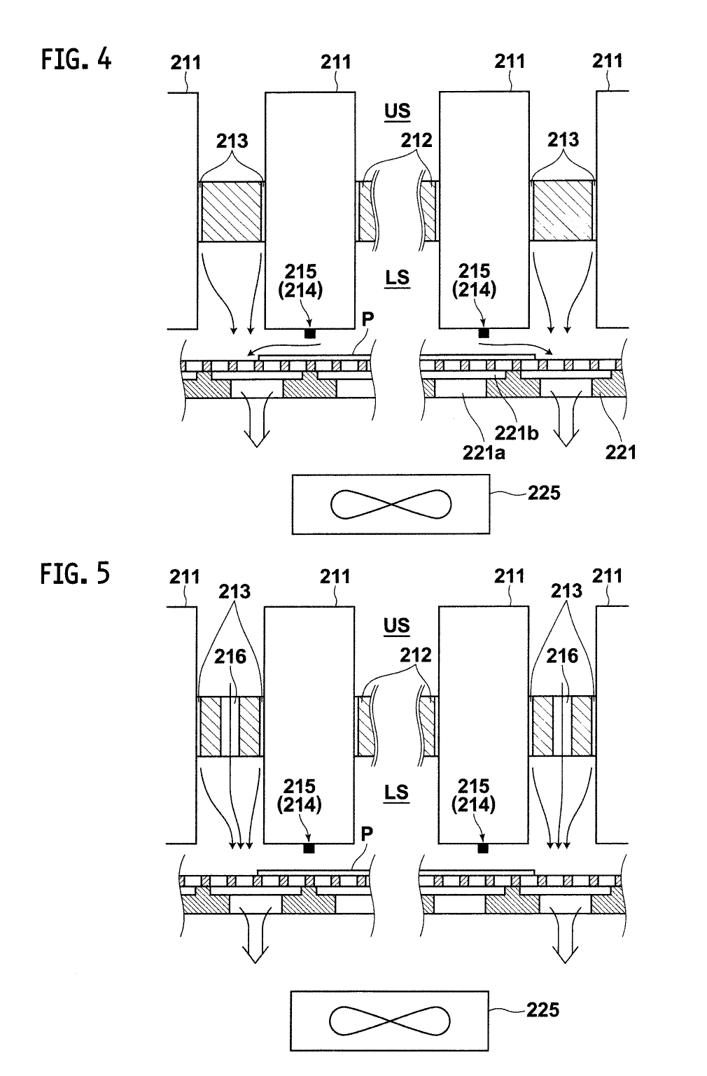

FIG. 4 is a fragmentary enlarged sectional view of the printing section 20. FIG. 4 illustrates a state when a printing starts. As mentioned above, when any belt hole 222a passes over a recess 221b, suction forces are produced at the belt hole 222a, with the suction forces getting maximal when the belt hole 222a passes over the through hole 221a. When a belt hole 222a, among an array of belt holes, that is not completely closed up with the paper P passes over a certain recess 221b, air from above the platen belt 222 flows into the spatial region under the platen belt 222 via belt holes 222a, recesses 221b and through holes 221a, creating air streams as illustrated with arrowed lines in the figure. Those streams of air become strongest, when the belt hole 222a passes over through holes 221a.

Those streams of air include such streams of air as flowing between the paper sheet P and some inkjet heads 211. If such streams of air increase, they may cause ink mist from inkjet nozzles to diffuse, increasing tendencies of staining printed images.

According to the first embodiment, an inkjet printer includes a head holder 212 provided with an air communication hole 216. As illustrated in FIG. 5, the air communication holes permits communication of air between an upper spatial region US and a lower spatial region LS in a range of projection PR of a platen 221. This allows satellites to be reduced. The projection range of the platen 221 is a region in which the platen 221 overlaps a head holder, when viewed from right above the printer. In the embodiment shown in FIG. 5, a plurality of air communication holes 216 are provided between inkjet heads 211.

The air communication holes 216 may have arbitrary locations, shapes, and sizes on the head holder 212, provided that they reside within the projection range PR of the platen 221. Preferably, a plurality of air communication holes 216 are opened in the vicinities of each of a plurality of inkjet heads 211, having a total open area of at least 10 percent, preferably at least 20 percent, more preferably at least 50 percent of a total area of the inkjet heads 211 projected on the head holder 212. The total open area of the air communication holes 216 thus formed in the head holder 212 should however be 90 percent or less of the total projection area of the inkjet heads 211, from the viewpoint of the mechanical strength of the head holder 212.

This arrangement allows to make the air above the belt holes 222a that are not closed up with the paper sheet P flow into the belt holes 222a more easily than the air between the paper sheet P and inkjet heads 211. This reduces streams of air flowing between the paper sheet P and inkjet heads 211, resulting in reduced stains by ink mist.

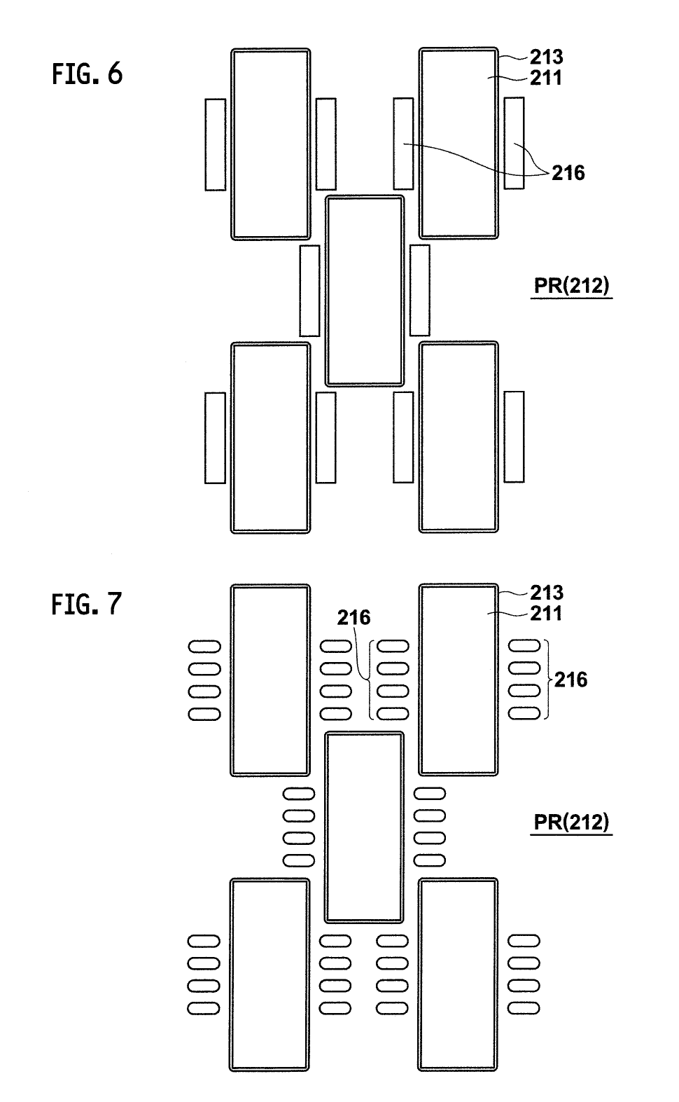

According to a second embodiment of the present invention, air communication holes 216 are formed in regions vicinal to both sides of inkjet heads 211. FIG. 6 illustrates air communication holes 216 according to the second embodiment. In this embodiment illustrated in FIG. 6, the air communication holes 216 are formed in a rectangular shape. The longer sides of air communication holes 216 of the rectangular shape extend in vicinities of and alongside of the two longer sides of an inkjet head 211 rectangular in plan. Here, the vicinities of the inkjet head 211 are regions within a range of distances up to 15 mm, preferably up to 10 mm, more preferably up to 5 mm from the inkjet head 211.

In the second embodiment, where each of inkjet heads 211 has air communication holes 216 opened at both sides extending in vicinities of and alongside of the inkjet head 211, air communication holes 216 should have a total open area of at least 10 percent, preferably at least 20 percent, more preferably at least 50 percent of a total projection area of the inkjet heads 211. The total open area of the air communication holes 216 should however be 90 percent or less of the total projection area, from the viewpoint of the mechanical strength of the head holder 212.

FIG. 6 illustrates an example of rectangular air communication holes 216 each formed along one longer side of an inkjet head 211 with a total area of air communication holes 216 of about 27 percent of a total projection area of the inkjet head 211 on the head holder 212.

FIG. 7 illustrates a modification of the second embodiment. Although the air communication holes 216 described above with reference to FIG. 6 are opened in a rectangular shape with each hole located in the vicinity and along a longer side of an inkjet head 211, the shapes of holes may be square, oblong, ellipse, true circle, or triangle. For a triangle hole, it is preferably arranged in such a way that its base is located near the side of an inkjet head 211. In FIG. 7, air communication holes 216 have an identical shape to the elongate shape of through holes 221a.

Each inkjet head 211 may have two or more air communication holes 216 formed on each of two sides thereof, without being limited to the example of FIG. 6 that has one hole on each side. In the example of FIG. 7, four air communication holes 216 are formed on each of both sides of an inkjet head 211.

For any inkjet head 211, the above-noted both sides may be two sides in a main scan direction or two sides in each of the main scan direction and a sub-scan direction of the inkjet head 211, without being limited to the two sides in a sub-scan direction as illustrated in FIG. 6. In other words, air communication holes 216 may be formed between zigzagged arrays of inkjet heads 211.

The size of air communication hole 216 is not limited, either, so far as a total open area of the communication holes 216 is in the range of at least 10 percent of a total area of projections of inkjet heads 211 on the head holder 212. Accordingly, in the example of FIG. 7, each air communication hole 216 may be smaller than a through hole 221a.

Proving air communication holes 216 in the vicinities of each side of an inkjet head 211 as mentioned above facilitates the air, which exists near the inkjet head 211 and above the belt holes 222a that are not closed up with a paper sheet P, to flow along the inkjet heads 211 to reduce streams of air flowing between the paper sheet P and the inkjet heads 211, resulting in reduced stains by ink mist.

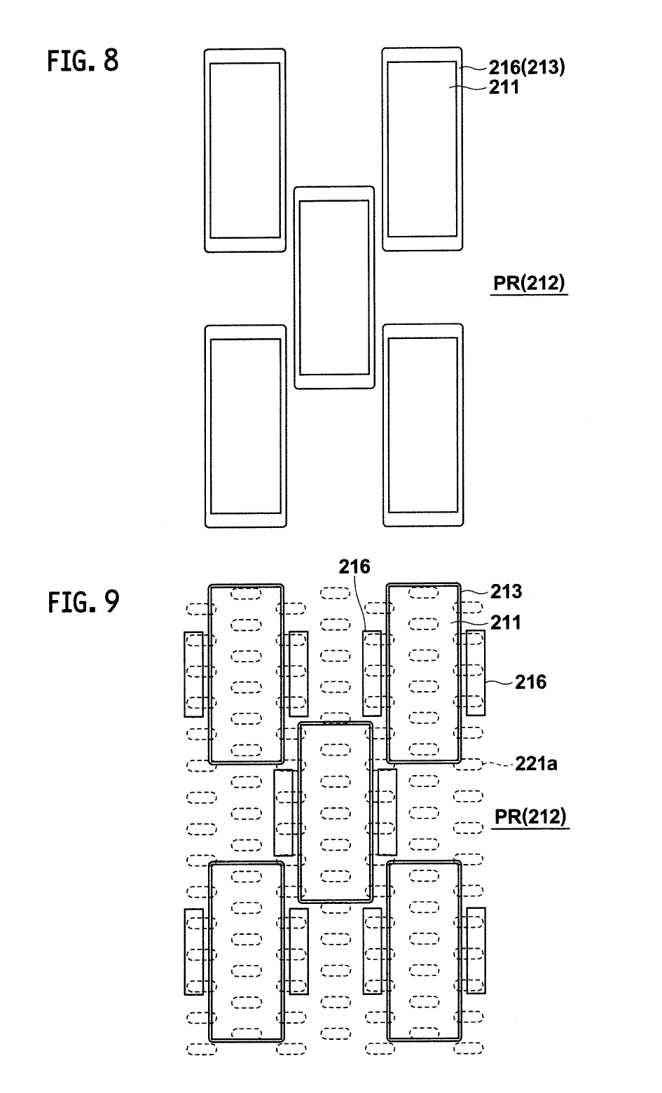

Description is now made of air communication holes 216 according to a third embodiment. In this embodiment, a part of a fixing hole 213 functions as an air communication hole 216. FIG. 8 illustrates air communication holes 216 according to the third embodiment. In this embodiment, each fixing hole 213 has an air communication hole 216 formed therearound in a rectangular shape with an outer circumference expanded in such a manner as outwardly offsetting four sides of the fixing hole 213.

According to the third embodiment, a total area of the gap between a fixing hole 213 and an inkjet head 211 is in the range of at least 10 percent, preferably at least 20, more preferably at least 50 percent of a total projection area of the inkjet heads 211. The total area of air gaps of air communication holes 216 formed in a head holder 212 should however be 90 percent or less of the total projection area from the viewpoint of the mechanical strength of the head holder 212.

FIG. 8 illustrates a sub-array of inkjet heads 211, which have the identical projection area to those of the first embodiment, having air communication holes 216 according to the third embodiment. In the third embodiment, each fixing hole 213 in which an inkjet head 211 is inserted has an air communication hole 216 defined therearound in the above-mentioned shape, so that the air communication hole 216 has an open area of about 32 percent of a projection area of the inkjet head 211 on the head holder 212.

Such use of fixing holes 213 facilitates the air, which exists near the inkjet head 211 and above the belt holes 222a that are not closed up with a paper sheet P, to flow along the inkjet heads 211, reducing stains by ink mist by reducing streams of air flowing between the paper sheet P and the inkjet heads 211.

The air communication holes 216 are arranged in such a manner that they include at least a part of projection areas of through holes 221a. FIG. 9 shows an example according to a fourth embodiment of the present invention. The fourth embodiment is an application of the aforesaid arrangement to the second embodiment. It may be applied to the first and third embodiments, too.

As mentioned above, streams of air entrained on a platen belt 222 become strongest when belt holes 222a that are not closed up with a paper sheet P pass over through holes 221a. Hence, as illustrated in FIG. 9, by forming air communication holes 216 in such a manner that they include at least parts of projections of through holes 221a as shown by broken lines in the figure, the air which is present near the inkjet head 211 and above the belt holes 222a that are not closed up with a paper sheet P tends to flow along the inkjet heads 211, reducing stains by ink mist by reducing streams of air flowing between the paper sheet P and the inkjet heads 211.

In the first to fourth embodiments, providing a pressure controller 218 in the spatial region US as shown in FIG. 1 to control the inner pressure of the spatial region US to set higher than the atmospheric pressure, with the spatial region US above the head holder 212 being tightly closed by non-depicted frame or the like, enables the air between belt holes 222a that are not closed up with a paper sheet P and the head holder 212 to flow into the holes 222a more easily than the air between paper P and inkjet heads 211. It is noted that the first to fourth embodiments may be combined as necessary for application.

Now, the ink composition used in the aforesaid printer will be explained. The ink composition comprises a pigment, a pigment dispersant in such an amount that a mass ratio in solid content of the pigment dispersant to the pigment ranges from 0.2 to 2.0, and an organic solvent. The pigment dispersant comprises component (A) soluble in the organic solvent, and the component (B) dispersed in the ink composition. Each component will be explained below.

<(A) A Polyamide Having a Polyester Side Chain and/or a Copolymer of Vinylpyrrolidone and a C₁₀₋₄₀ Alkene>

Examples of the polyamide having a polyester side chain include a dispersant having a main chain comprising a nitrogen atom such as polyethyleneimine and a plurality of side chains having a polyester moiety bonded via an amide bond comprising the nitrogen atom to the main chain. An illustrative example is a comb-shaped dispersant described in Japanese Patent Laid-Open No. H5-177123, or U.S. Pat. No. 4,645,611, having a polyalkyleneimine such as polyethyleneimine main chain and a side chain that is bonded to a nitrogen atom of the main chain and has 3 to 80 repeating units of the following formula:

—[C(═O)—R¹O]— (1)

wherein R¹ is a C₃₋₆ alkylene group. The polyamide dispersants having the aforesaid structure are commercially available under the trade names of Solsperse 11200, and Solsperse 28000 from Lubrizol Japan Ltd.

In the copolymer of vinylpyrrolidone (VP) and a C₁₀₋₄₀ alkene, which hereinafter may be referred to as “alkylated PVP”, C₁₀₋₄₀ alkene may be decene, undecene, dodecene, tridecene, tetradecene, pentadecene, hexadecene, heptadecene, octadecene, nonadecene, icosene, eicosene, docosene, triacontene or the like. Of these, copolymers formed from a C₁₂₋₂₄ alkene are preferred from the viewpoint of dispersion stability, and the use of a VP-hexadecene copolymer, VP-eicosene copolymer or VP-triacontene copolymer or the like is particularly desirable. The copolymer may include a plurality species of alkenes. As for the copolymerization ratio (molar ratio) of the VP and the alkene is preferably such that VP:alkene ranges from 1:9 to less than 5:5, and is more preferably ranges from 2:8 to 4:6, in order to control the polarity of the copolymer. The molecular weight (the weight average molecular weight measured by GPC using polystyrene standards) of the alkylated PVP is preferably within a range from 3,000 to 50,000, and more preferably from 5,000 to 30,000. Examples of commercially available alkylated PVP copolymers include VP-hexadecene copolymers marketed under the product names, Antaron V-216 and Ganex V-216 (both ex ISP Corporation) and Unimer U-151 (ex Induchem AG), and VP-eicosene copolymers marketed under the product names Antaron V-220 and Ganex V-220 (both ex ISP Corporation) and Unimer U-15 (ex Induchem AG). The ink composition may comprise a plurality of different alkylated-PVP copolymers.

<(B) Alkyl (alkyl)acrylate Copolymer>

Component (B) is dispersed in the ink composition, whereby viscosity of the ink composition is stabilized. Any alkyl (alkyl)acrylate copolymer that can be dispersed in the composition can be used. In this text, the term “alkyl (alkyl)acrylate” encompasses alkyl esters of acrylic acid and alkyl esters of (alkyl)acrylic acid such as methacrylic acid. Examples of the alkyl (alkyl)acrylate copolymer include resin particles having a core of a C1-4 alkyl ester of poly(meth)acrylic acid and a shell of C4-10 alkyl ester of poly(meth)acrylic acid as described in Japanese Patent Application Laid-Open No. 2005-171032, and resin particles of copolymer of C12-25 alkyl ester of poly(meth)acrylic acid with acrylic monomers having specific groups such as glycidyl group capable of dispersing pigment as described in Japanese Patent Application Laid-Open No. 2007-197500.

Preferably, the alkyl (alkyl)acrylate copolymer has a backbone comprising repeating units of the formula (2), and an urethane side chain or crosslinking, hereinafter referred to as “urethane moiety”, comprising repeating units of the formula (3):

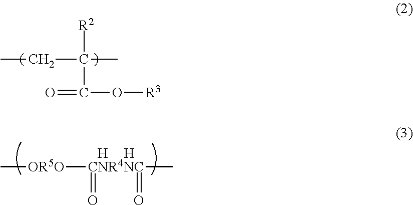

wherein R² is a hydrogen atom or a C₁₋₃ alkyl group, preferably methyl group, R³ is a C₁₂₋₂₅ alkyl group, R⁴ is a C₆₋₁₆ divalent hydrocarbon group, and R⁵ is a C₂₋₂₀ alkylene group or oxyalkylene group.

The alkyl(alkyl)acrylate copolymer has a long chain alkyl group having 12 to 25 carbon atoms, resulting in good affinity with the organic solvent. Examples of the alkyl group include dodecyl group, tridecyl group, tetradecyl group, pentadecyl group, hexadecyl group, heptadecyl group, octadecyl group, nonadecyl group, icosyl group, henicosyl group, docosyl group, isododecyl group, and isooctadecyl group, which may be branched. A mixture of two or more of these groups may be contained in the copolymer.

Meanwhile, the aforesaid urethane moiety is polar, which is considered to contribute to the good affinity with the pigment.

The alkyl (alkyl)acrylate copolymer can be prepared by the following method. In the first step, the polyalkyl (alkyl)acrylate backbone of the formula (2) is prepared by radically polymerizing (alkyl)acrylate monomer having a C₁₂₋₂₅ alkyl group. Because of the alkyl group, the copolymer has good affinity with the organic solvent. Examples of the alkyl group include dodecyl group, tridecyl group, tetradecyl group, pentadecyl group, hexadecyl group, heptadecyl group, octadecyl group, nonadecyl group, icosyl group, henicosyl group, docosyl group, isododecyl group, and isooctadecyl group, which may be branched. A mixture of two or more of these groups may be contained in the copolymer.

In the first step, an (alkyl)acrylate monomer having a glycidyl group is used as one of the co-monomers, which is subjected to the radical polymerization, and the resulting glycidyl group bonded to the backbone is then used for preparing a connecting moiety between the backbone and the urethane moiety of the formula (3). Examples of (alkyl)acrylate monomer having a glycidyl group include glycidyl (alkyl)acrylate, glycidyl ether of hydroxyalkyl (alkyl)acrylate such as 4-hydroxybutyl acrylate glycidyl ether, and 3,4-epoxycyclohexylmethyl (meth)acrylate, among which glycidyl (meth)acrylate is preferred. The (alkyl)acrylate monomer having a glycidyl group is contained preferably in an amount of 1 to 30% by mass, more preferably 3 to 25% by mass, and most preferably 10 to 20% by mass of a total mass of the monomers.

The use of a (alkyl)acrylate monomer having a β-diketone group, i.e., —C(═O)—C—C(═O)—), or β-keto ester group, i.e., —C(═O)—C—C(═O)OR, wherein R is a hydrocarbon group, as an additional co-monomer enables one to prepare an ink composition having a lower viscosity. By the use, in selecting a solvent for the ink, there will be fewer restrictions due to the viscosity of the solvent itself, thereby expanding the range of non-aqueous solvents that may be selected. Further, in those cases where fixing resins or additives are added to the ink composition as needed, the permissible increase in the ink composition viscosity caused by adding such components is expanded, resulting in a greater degree of freedom in determining the ink formulation. Moreover, β-diketone group or β-keto ester group suppresses agglomeration of pigments to suppress show-through of printed image and to increase printed image density.

Examples of the (alkyl)acrylate monomer having a β-diketone group or β-keto ester group include acetoacetoxyalkyl (alkyl)acrylates such as acetoacetoxyethyl (alkyl)acrylate, hexadione (alkyl)acrylate, and acetoacetoxyalkyl(alkyl)acrylamides such as acetoacetoxyethyl (alkyl)acrylamide. These monomers may be used individually, or in combinations of two or more monomers.

The amount of the (alkyl)acrylate monomer having a β-diketone group or β-keto ester group in the monomer mixture is preferably in the range from 3 to 30% by mass, and more preferably from 5 to 20% by mass.

Examples of other co-monomer include styrene-based monomers such as styrene and α-methylstyrene; vinyl acetate, vinyl benzoate; vinyl ether-based polymers such as butyl vinyl ether; maleic acid esters, fumaric acid esters, acrylonitrile, methacrylonitrile and α-olefins. Further, alkyl (alkyl)acrylates in which the ester-forming alkyl group has less than 12 carbon atoms may also be used, including 2-ethylhexyl (meth)acrylate, isooctyl (meth)acrylate and tert-octyl (meth)acrylate. These monomers may be used individually, or in combinations of two or more monomers.

The radical polymerization in the first step is preferably conducted in an organic solvent. In order to control molecular weight, the use of a chain transfer agent during polymerization is effective. Examples of the chain transfer agent include thiols such as n-butyl mercaptan, lauryl mercaptan, stearyl mercaptan and cyclohexyl mercaptan.

Examples of polymerization initiators that may be used include conventional thermal polymerization initiators, for example, azo compounds such as AIBN (azobisisobutyronitrile), and peroxides such as t-butyl peroxybenzoate and t-butylperoxy-2-ethylhexanoate (Perbutyl O, ex NOF Corporation). Alternatively, a photopolymerization initiator may be used, which generate radicals when irradiated with an active energy beam. As a polymerization solvent, petroleum-based solvents (such as aroma-free (AF) solvents) and the like can be used in a solution polymerization. This polymerization solvent is preferably one or more solvents selected from among those solvents that can be used also as the organic solvent in the ink composition, which will be listed later in the specification. During the polymerization reaction, other typically employed polymerization inhibitors, polymerization accelerators and dispersants and the like may also be added to the reaction system.

In the second step, the glycidyl group-containing polyalkyl (alkyl)acrylate backbone prepared in the first step is reacted with a compound having an alcoholic hydroxyl group and a group capable of reacting with glycidyl group to form a moiety connecting the urethane moiety of the formula (3) to the alkyl (alkyl)acrylate backbone. Examples of the compound having an alcoholic hydroxyl group and a group capable of reacting with glycidyl group include alcohols having an amino group or a carboxyl group, among which aminoalcohols are preferably used. Examples of the aminoalcohol include C₂₋₁₀ monoolamine such as monomethylethanolamine, C₄₋₂₀ diolamine such as diethanolamine, and diisopropanolamine, and a mixture thereof. Among these aminoalcohols, C₄₋₂₀ dialkanolamine particularly diethanolamine is preferred. The aminoalcohol is subjected to the reaction preferably in an amount of 0.05 to 1 mole equivalent per mole equivalent of the aforesaid glycidyl group.

The second step can be conducted by adding the aminoalcohol, and polyhydric alcohol as desired, to the copolymer solution obtained in the first step, and then heating, while stirring under a stream of nitrogen gas.

In the third step, a polyisocyanate compound is reacted with the polyalkyl (alkyl)acrylate backbone having alcoholic hydroxyl group prepared in the second step. Isocyanate groups remained unreacted are then reacted with polyhydric alcohols to form the urethane moiety. The polyhydric alcohol may be added in the second step. It is considered that the polyhydric alcohol hardly reacts with the glycidyl group, but it causes no problem even if it reacts. Examples of the polyhydric alcohol include polyhydric alcohol having a C₂₋₂₀ alkylene or oxyalkylene group such as ethylene glycol, propylene glycol, dipropylene glycol, 1,3-propanediol, polyethylene glycol, polypropylene glycol and a mixture of these alcohols. The polyhydric alcohol is used preferably in an amount of 10 moles or less, more preferably 1 to 5 moles per mole of the glycidyl-reactive group in the compound having glycidyl-reactive group and alcoholic hydroxyl group.

Examples of the polyisocyanate compound used in the third step include polyisocyanate compound having a C₆₋₁₆ aliphatic group such as an alkylene group, an alicyclic group such as cycloalkylene group, or an aromatic group such as arylene group, for example, 1,6-diisocyanatohexane, 1,3-bis(isocyanatomethyl)benzene, 1,3-bis(isocyanatomethyl)cyclohexane, 1,5-naphthalene diisocyanate, and a mixture of these compounds. In order to ensure that no unreacted alcoholic hydroxyl group remain, the isocyanate compound is preferably reacted in an amount that is substantially equimolar, that is, 0.98 to 1.02 molar equivalents, with the amount of alcoholic hydroxyl group.

The reaction in third step can be performed by adding the polyisocyanate compound to the copolymer solution obtained in the second step, and then heating the mixture in the presence of a catalyst such as a tin catalyst in accordance with a commonly used method.

The urethane moiety is contained in the alkyl (alkyl)acrylate copolymer (B) in an amount of from 1 to 40% by mass, preferably from 1 to 30% by mass, and more preferably from 5 to 20% by mass. The mass of the urethane moiety corresponds to a total mass of the aminoalcohol, the polyhydric alcohol, and the isocyanate compound used in the reaction.

The alkyl (alkyl)acrylate copolymer (B) has a weight average molecular weight determined by GPC of from 5,000 to 50,000, preferably from 8,000 to 30,000. The use of a copolymer having a lower molecular weight than the aforesaid lower limit tends to degrade storage stability of an ink composition, while the use of a copolymer having a higher molecular weight than the aforesaid higher limit tends to increase a viscosity of an ink composition, degrading ejection stability of an ink composition.

The component (A), which is dissolved in the organic solvent, and component (B), which is dispersed in the organic solvent, are contained in the ink composition in such an amount that a ratio of their total mass to the pigment mass ranges from 0.2 to 2.0, preferably from 0.2 to 1.5, more preferably from 0.2 to 1.0. If the ratio is below the aforesaid lower limit, a sufficient dispersing effect would not be achieved. On the other hand, an ink composition with the ratio being higher than the aforesaid upper limit would have a higher viscosity, showing poorer ink ejection stability. A mass ratio of the component (B) to a total of components (A) and (B), i.e., (B)/[(A)+(B)], ranges from 0.8 to 0.99, preferably from 0.8 to 0.95. If the ratio exceeds the aforesaid higher limit, storage stability would be worse. On the other hand, satellites would not be sufficiently prevented if the ratio is below the aforesaid lower limit.

### <Pigment>

In the present ink composition, pigment is not limited to a particular one.

Examples of black pigment include carbon blacks such as furnace black, lamp black, acetylene black and channel black; metals or metal oxides such as copper, iron and titanium oxide; and organic pigments such as orthonitroaniline black. These pigments may be used either individually, or in combinations of two or more different pigments. Preferred pigment in terms of high printed image density is carbon black pigment having a dibutyl phthalate (DBP) oil absorption number, measured according to Japanese Industrial Standards (JIS) K6221, of from 80 cm³/100 to 140 cm³/100 g and a BET specific surface area, measured by using nitrogen gas according to JIS K6217, of from 100 m²/g to 200 m²/g.

Examples of pigments that may be used for color inks include toluidine red, permanent carmine FB, disazo orange PMP, lake red C, brilliant carmine 6B, quinacridone red, dioxane violet, orthonitroaniline orange, dinitroaniline orange, vulcan orange, chlorinated para red, brilliant fast scarlet, naphthol red 23, pyrazolone red, barium red 2B, calcium red 2B, strontium red 2B, manganese red 2B, barium lithol red, pigment scarlet 3B lake, lake bordeaux 10B, anthocyn 3B lake, anthocyn 5B lake, rhodamine 6G lake, eosine lake, iron oxide red, naphthol red FGR, rhodamine B lake, methyl violet lake, dioxazine violet, naphthol carmine FB, naphthol red M, fast yellow AAA, fast yellow 10G, disazo yellow AAMX, disazo yellow AAOT, disazo yellow AAOA, disazo yellow HR, isoindoline yellow, fast yellow G, disazo yellow AAA, phthalocyanine blue, Victoria pure blue, basic blue 5B lake, basic blue 6G lake, fast sky blue, alkali blue R toner, peacock blue lake, Prussian blue, ultramarine, reflex blue 2G, reflex blue R, alkali blue G toner, brilliant green lake, diamond green thioflavine lake, phthalocyanine green G, green gold, phthalocyanine green Y, iron oxide powder, rust powder, zinc white, titanium oxide, calcium carbonate, clay, barium sulfate, alumina white, aluminum powder, bronze powder, daylight fluorescent pigments, and pearl pigments. These pigments may be used either individually, or in arbitrary mixtures.

From the viewpoints of ink ejection stability and storage stability, the average particle size of the pigment is preferably not more than 300 nm, more preferably not more than 150 nm, and most preferably 100 nm or less. Here, the average particle size of the pigment may be measured using a dynamic light-scattering particle size distribution measurement apparatus, for example, LB-500 manufactured by Horiba, Ltd.

The pigment preferably contained in the ink composition in an amount of from 5 to 15% by mass, more preferably from 5 to 10% by mass from the viewpoints of printed image density and viscosity of the ink composition.

### <Organic Solvent>

The ink composition of the present invention is non-aqueous, that is, the dispersion medium of the pigments is composed of organic solvents. Examples of the organic solvents include non-polar solvents such as aliphatic hydrocarbon solvents, alicyclic hydrocarbon solvents, and aromatic hydrocarbon solvents; and polar solvents such as ester solvents, alcohol solvents, higher fatty acid solvents, and ether solvents. Examples of the aliphatic hydrocarbon solvents and alicyclic hydrocarbon solvents include Teclean N-16, Teclean N-20, Teclean N-22, Nisseki Naphtesol L, Nisseki Naphtesol M, Nisseki Naphtesol H, No. 0 Solvent L, No. 0 Solvent M, No. 0 Solvent H, Nisseki Isosol 300, Nisseki Isosol 400, AF-4, AF-5, AF-6 and AF-7, all manufactured by JX Nippon Oil & Gas Exploration Co., and Isopar G, Isopar H, Isopar L, Isopar M, Exxsol D40, Exxsol D80, Exxsol D100, Exxsol D130 and Exxsol D140, all manufactured by Exxon Mobil Corporation. Examples of the aromatic hydrocarbon solvents include Nisseki Cleansol G (alkylbenzene) manufactured by JX Nippon Oil & Gas Exploration Co., and Solvesso 200 manufactured by Exxon Mobil Corporation.

Examples of the ester solvents include methyl laurate, isopropyl laurate, hexyl laurate, isopropyl myristate, isopropyl palmitate, isooctyl palmitate, methyl oleate, ethyl oleate, isopropyl oleate, butyl oleate, methyl linoleate, isobutyl linoleate, ethyl linoleate, isopropyl isostearate, methyl soybean oil, isobutyl soybean oil, methyl tallate, isobutyl tallate, diisopropyl adipate, diisopropyl sebacate, diethyl sebacate, propylene glycol monocaprate, trimethylolpropane tri-2-ethylhexanoate and glyceryl tri-2-ethylhexanoate. Examples of the alcohol solvent include isomyristyl alcohol, isopalmityl alcohol, isostearyl alcohol and oleyl alcohol. Examples of the higher fatty acid solvents include isononanoic acid, isomyristic acid, hexadecanoic acid, isopalmitic acid, oleic acid and isostearic acid. Examples of the ether solvents include diethylene glycol monobutyl ether, ethylene glycol monobutyl ether, propylene glycol monobutyl ether and propylene glycol dibutyl ether. A mixture of two or more of these solvents can be used. Preferably, the ester solvents, particularly isooctyl parmitate, and hexyl laurate, are used.

### <Optional Components>

The ink composition of the present invention can contain an optional component in such an amount that it does not impair the effects the present invention. For example, a resin may be added besides the above components (A) and (B). Examples of the resin include acrylic resins, styrene-acrylic resins, styrene-maleic acid resins, rosin-based resins, rosin ester-based resins, ethylene-vinyl acetate resins, petroleum resins, coumarone-indene resins, terpene phenol resins, phenolic resins, urethane resins, melamine resins, urea resins, epoxy resins, cellulose-based resins, vinyl chloride acetate resins, xylene resins, alkyd resins, aliphatic hydrocarbon resins, butyral resins, maleic acid resins, fumaric acid resins, hydroxyl group-containing carboxylate esters, salts of long-chain polyaminoamides and high-molecular weight acid esters, salts of high-molecular weight polycarboxylic acids, salts of long-chain polyaminoamides and polar acid esters, high-molecular weight unsaturated acid esters, high-molecular weight copolymers, modified polyurethanes, modified polyacrylates, polyether ester anionic surfactants, naphthalenesulfonic acid-formalin condensate salts, aromatic sulfonic acid-formalin condensate salts, polyoxyethylene alkyl phosphate esters, polyoxyethylene nonylphenyl ethers, polyester polyamines, and stearyl amine acetate.

Preferably, the present ink composition contains a synergist. Synergists are derivatives of pigments having a polar group introduced to the pigment skeleton. Examples of the pigment skeleton include azo pigments, phthalocyanine pigments, quinacridone pigments, perylene pigments, isoindoline pigments, benzimidazolone pigments, pyranthrone pigments, thioindigo pigments, and quinophthalone pigments. Example of the polar group include alkylamino group, carboxyl group, sulfonic acid group, and phthalimide group. Among these, phthalocyanine pigments, particularly copper phthalocyanine blue synergists having a polar group such as sulfonic acid and amino group, for example, copper phthalocyanine blue sulfonate such as Solsperse 5000, Solsperse 12000, and Solsperse 22000, all available from Lubrizol Japan Ltd., are preferred. Other additives such as nozzle blockage prevention agents, antioxidants, conductivity modifiers, viscosity modifiers, surface tension modifiers and oxygen absorbers and the like may also be added.

The ink composition of the present invention can be prepared by placing a mixture of the components (A), the components (B) and the organic solvent, pigment, and additional organic solvent to adjust the viscosity of the ink composition, if needed, and an optional component as desired in a lump or in several parts in a disperser such as a bead mill, and stirring to mix them followed by filtering the mixture with a filter such as a membrane filter as desired.

The viscosity of the ink, though the suitable range thereof varies depending on several factors such as the diameter of ejecting head nozzles and ejecting environment, is preferably in the range of from 5 to 30 mPa·s, more preferably from 5 to 15 mPa·s, and most preferably about 10 mPa·s at 23° C. Here, the values of the viscosity are those measured at 23° C. by raising the shear stress from 0 Pa to 10 Pa at a rate of 0.1 Pa/s.

By using the ink composition in the aforesaid inkjet printer, occurrence of satellites is significantly suppressed even in the printing on a thick printing medium such as an envelope.

### EXAMPLES

The present invention will be explained with reference to the examples described below, although the present invention is in no way limited by these examples.

Preparation of Alkyl (alkyl)acrylate Copolymer (B)

A 300 ml four-neck flask was charged with 75 g of AF-4 (a naphthene type solvent, ex JX Nippon Oil & Gas Exploration Co.), and the temperature was raised to 110° C. under a stream of nitrogen gas while stirring. Subsequently, with the temperature maintained at 110° C., a mixture of 50 g of behenyl methacrylate, 35 g of 2-ethylhexyl methacrylate, and 15 g of glycidyl methacrylate was fed in the flask, to which a mixture of 16.7 g of AF-4, and 2 g of Perbutyl 0 (t-butylperoxy-2-ethylhexanoate, ex NOF Corporation) was added dropwise over a period of 3 hours. Then, with the temperature maintained at 110° C., 0.2 g of Perbutyl 0 was added after an additional one hour and two hours respectively. The reaction mixture was aged for additional one hour, and then diluted with 10.6 g of AF-4, whereby a colorless and transparent solution of a backbone polymer with a non-volatile content of 50% was obtained. The polymer obtained had a weight average molecular weight (determined by GPC method using polystyrene standards) of from 20,000 to 23,000.

Subsequently, a 500 ml four-neck flask was charged with 81 g of isooctyl palmitate (10P, ex Nikko Chemicals Co., Ltd.), 200 g of the above polymer solution obtained (with a solid content of 50% in AF-4), 4.0 g of propylene glycol, 2.8 g of diethanolamine, and the temperature was raised to 110° C. under a stream of nitrogen gas while stirring. After maintaining the temperature at 110° C. for one hour, 0.2 g of dibutyltin dilaurate was added, and a mixture of 10.2 g of Takenate 600 (1,3-bis(isocyanatemethyl)cyclohexane, ex Mitsui Polyurethane Co.) and 91.8 g of IOP was added dropwise to the flask over a period of one hour. Following the completion of the addition, the temperature was raised to 120° C. at which temperature the reaction was allowed to proceed for 6 hours. Subsequently, the reaction mixture was cooled, whereby a dispersion of dispersant resin with a solid content of 30%, herein after referred to as “dispersant 1”, was obtained. The polymer obtained had a weight average molecular weight (determined by GPC method using polystyrene standards) of from 22,000 to 26,000 and a content of urethane moiety of 10% by mass.

### <Preparation of Ink Composition>

Each non-aqueous ink composition was prepared by placing in a glass container the components according to the formulation (% by mass) shown in Table 1, and 80 g of zirconia beads (diameter: 0.5 mm), and then shaking the container using a rocking mill (Model RM05S, ex Seiwa Technical Lab Co., Ltd.) at 60 Hz for 2 hours.

Details of the components indicated in Table 1 are as follows:

Carbon black: MA-100 having a DBP absorption number of 100 cm³/100 g and a specific surface area by nitrogen adsorption of 110 m²/g, ex Mitsubishi Chemical Co.

(A) polyvinylpyrrolidone: Antaron V-216, VP/hexadecene copolymer, ex ISP Co.

(A) polyamide: Solsperse 11200, ex Lubrizol Japan Ltd.

Comparative pigment dispersant: Disperbyk-101, a long-chain polyamideamide salt of an acid ester, ex BYK-Chemie GmbH.

Synergist: Solsperse 5000, ex Lubrizol Japan Ltd.

AF-4: a naphthene type solvent, ex JX Nippon Oil & Gas Exploration Co.

Ink compositions prepared were evaluated according to the following methods. Results are shown in Table 1 in which “Ex.” stands for example, and “Comp.Ex.” for comparative example.

### <Storage Stability of Ink Composition>

At a temperature of 23° C., an initial viscosity of each ink composition was measured using a rheometer RS300, ex Haake GmbH, at 10 Pa by raising a shear stress from 0 Pa at a rate of 0.1 Pals to 10 Pa. Then, 30 g of the ink composition were placed in a sealed 50 ml-glass container and left to stand for 3 months at 70° C., and then the viscosity of the composition was measured in the similar manner as above. A viscosity change percentage was calculated according to the following equation, which was then rated according to the following criteria.

Viscosity change percentage=100×(viscosity after 3 months−initial viscosity)/initial viscosity

| Grade | Viscosity change, % |
|---|---|
| A | less than 5% decrease or increase |
| B | 5% of larger decrease |
| C | 5% or larger increase |

<Staining with Satellites>

In an environment of a temperature of 15° C., printing was performed on A4 size paper using ORPHIS-X, ex Riso Kagaku Co., equipped with a head holder having air communication holes according to the embodiment shown in FIG. 6 with a total open area of about 15% of a total area of the inkjet head projected on the head holder. Printing was performed under the printing conditions of a head gap of 3 mm, a printing speed of 120 ppm, a resolution of 300 dpi×300 dpi, and 6 drops/dot. The printed image was evaluated according to the following criteria.

A: Staining with satellites was hardly found with good image quality.
B: A little staining with satellites was found, but with tolerable image quality for practical use.
C: Too much staining with satellites for practical use.

TABLE 1

| | | | | | Comp. | Comp. | Comp. | Comp. | Comp. |
|---|---|---|---|---|---|---|---|---|---|
| | | Ex. 1 | Ex. 2 | Ex. 3 | Ex. 1 | Ex. 2 | Ex. 3 | Ex. 4 | Ex. 5 |
| Pigment | Carbon black | 8 | 8 | 4 | 8 | 8 | 8 | 5 | 8 |
| Pigment dispersant | (A)Polyvinylpyrrolidone | | 1 | | | | | | |
| | (A)Polyamide(solid content 50%) | 1 | | 0.3 | 5 | | 5 | 0.2 | |
| | (B)Dispersant 1 (solid content 30%) | 20 | 20 | 2.5 | | 20 | 20 | 2.5 | 20 |
| | Comparative pigment dispersant | | | | | | | | 2 |
| Organic solvent | AF-4 | 40 | 40 | 55.5 | 40 | 40 | 40 | 55.5 | 40 |
| | Isooctyl palmitate | 25.7 | 25.7 | 32.4 | 41.7 | 26.7 | 21.7 | 31.5 | 24.7 |
| | Isomyristyl alcohol | 5 | 5 | 5 | 5 | 5 | 5 | 5 | 5 |

| | | | | | | | | |
|---|---|---|---|---|---|---|---|---|
| Synergist | 0.3 | 0.3 | 0.3 | 0.3 | 0.3 | 0.3 | 0.3 | 0.3 |
| Total | 100 | 100 | 100 | 100 | 100 | 100 | 100 | 100 |
| Solid content of component (B) in ink | 6 | 6 | 0.8 | 0 | 6 | 6 | 0.8 | 6 |
| Solid content of component (A) in ink | 0.5 | 1 | 0.2 | 2.5 | 0 | 2.5 | 0.1 | 1 |
| (B)/[(A) + (B)] | 0.92 | 0.86 | 0.83 | 0 | 1 | 0.71 | 0.88 | 0.85 |
| [(A) + (B)]/pigment | 0.81 | 0.88 | 0.23 | 0.31 | 0.75 | 1.06 | 0.17 | 0.88 |
| Storage stability | A | A | B | A | C | A | C | C |
| Staining with satellite | A | A | A | C | A | C | B | B |

Almost no staining with satellites were found in the combinatory use of the ink composition of Examples 1 to 3 and the present inkjet printer. On the other hand, staining of images with satellites was notable for the ink composition of comparative examples 1 and 3, both having (B)/[(A)+(B)] of less than 0.8. The ink composition of the comparative example 4 having insufficient amount of the dispersants, and the ink composition of comparative example 5 containing a dispersant which is not pertinent to the present invention showed worse storage stability. The ink composition of comparative example 2 lacking component (A) showed a little satellite, but showed poor storage stability with a viscosity increase.

### INDUSTRIAL APPLICABILITY

The present inkjet printing system is very useful for high-speed inkjet printing without staining caused by satellites.

It should be noted that, besides those already mentioned above, various modifications and variations can be made in the aforementioned embodiments without departing from the novel and advantageous features of the present invention. Accordingly, it is intended that all such modifications and variations are included within the scope of the appended claims.

### LIST OF REFERENCES

LS Lower spatial region
P Paper
PR Projection range
US Upper spatial region
1 Inkjet printer
211 Inkjet head
212 Head holder
213 Fixing hole
214 Inkjet nozzle
216 Air communication hole
221 Platen
221a Through hole
222 Platen belt

1. An inkjet printing system using a non-aqueous ink composition,
the inkjet printer comprising:
a inkjet head configured to hold a non-aqueous ink composition;
a head holder configured to hold the inkjet head;
a platen disposed under the head holder in a position opposing the head holder, the platen having a plurality of through holes formed therethrough;
a suction device configured to produce suction forces at the plurality of through holes; and
a porous platen belt configured to travel on the platen, and to suction a sheet of paper thereon to transfer, wherein
the head holder is configured to define an upper spatial region and a lower spatial region relative to the head holder, and is provided with a plurality of air communication holes for air communication between the upper spatial region and the lower spatial region, within a range of a projection of the platen on the head holder, and
the non-aqueous ink composition comprises a pigment, a pigment dispersant in such an amount that a mass ratio in solid content of the pigment dispersant to the pigment ranges from 0.2 to 2.0, and an organic solvent, the pigment dispersant comprising
(A) a polyamide having a polyester side chain and/or a copolymer of vinylpyrrolidone and a C₁₀₋₄₀ alkene, and
(B) an alkyl (alkyl)acrylate copolymer.

2. The inkjet printing system according to claim 1, wherein the air communication holes have a total open area of at least 10 percent of a total projection area of the inkjet heads on the head holder.

3. The inkjet printing system according to claim 1, wherein
the inkjet printing system comprises a plurality of inkjet heads, each inkjet head being held in the inserted state in a fixing hole, and
the air communication hole is provided in the vicinity of each fixing hole.

4. The inkjet printing system according to claim 1, wherein a mass ratio of the component (B) to a total of components (A) and (B), i.e., (B)/[(A)+(B)], ranges from 0.8 to 0.99.

5. The inkjet printing system according to claim 1, wherein the polyamide having a polyester side chain (A) has a polyethyleneimine main chain and a side chain that is bonded to a nitrogen atom of the main chain and has 3 to 80 repeating units of the following formula:
—[C(═O)—R¹O]— (1)
wherein R¹ is a C₃₋₆ alkylene group.

6. The inkjet printing system according to claim 1, wherein the copolymer of vinylpyrrolidone and a C₁₀₋₄₀ alkene (A) is a copolymer of vinylpyrrolidone and hexadecene having a weight average molecular weight of from 3,000 to 50,000.

7. The inkjet printing system according to claim 1, wherein the alkyl (alkyl)acrylate copolymer (B) has a backbone comprising repeating units of the formula (2), and an urethane side chain or crosslinking comprising repeating units of the formula (3): 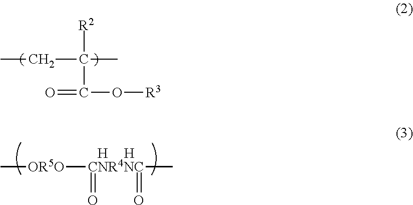
wherein R² is a hydrogen atom or a C₁₋₃ alkyl group. R³ is a C₁₂₋₂₅ alkyl group, R⁴ is a C₆₋₁₆ divalent hydrocarbon group, and R⁵ is a C₂₋₂₀ alkylene group or oxyalkylene group.
